(19) United States
(12) Patent Application Publication
(10) Pub. No.: US 2014/0062428 A1
(43) Pub. Date: Mar. 6, 2014

(54) FEEDBACK DETECTION CIRCUIT

(71) Applicants: Shian-Sung Shiu, New Taipei City (TW); Ke Peng, Wuxi (CN); Li-Min Lee, New Taipei City (TW); Ying Wang, Wuxi (CN); Yong Huang, Wuxi (CN)

(72) Inventors: Shian-Sung Shiu, New Taipei City (TW); Ke Peng, Wuxi (CN); Li-Min Lee, New Taipei City (TW); Ying Wang, Wuxi (CN); Yong Huang, Wuxi (CN)

(73) Assignee: GREEN SOLUTION TECHNOLOGY CO., LTD., New Taipei City (TW)

(21) Appl. No.: 13/604,635

(22) Filed: Sep. 6, 2012

(51) Int. Cl. G05F 1/10

(52) U.S. Cl. 323/234

(57) ABSTRACT

Disclosed is a feedback detection circuit, adapted to provide a feedback detection signal wherein a converting circuit provides a driving power source to drive a load according to the feedback detection signal. The feedback detection circuit comprises an operational conversion circuit and a signal limitation circuit. The operational conversion circuit generates the feedback detection signal in response to a level of a detected node of the load. The operational conversion circuit has an operational amplifier, which modulates the level of the feedback detection signal in response to the level of the detected node. The signal limitation circuit is coupled to the operational conversion circuit for clamping a level rang of the feedback detection signal.

### BACKGROUND OF THE INVENTION

(1) Field of the Invention

The present invention relates to a feedback detection circuit, and more particularly relates to a feedback detection circuit with fast transient response.

(2) Description of the Prior Art

In a feedback control system, a feedback detection circuit may use an IC therein to provide some specific functions, such as: isolation. For example, please refer FIG. 1, which is a schematic diagram of a conventional photo-coupler feedback circuit. A photo-coupler PC of the photo-coupler feedback circuit is capable of providing a fine isolation between an input and an output. For controlling the photo-coupler PC, the photo-coupler feedback circuit uses an adjustable shunt regulator TL431. A voltage divider VD generates a voltage-dividing signal according to an output voltage Vout to a reference end of the adjustable shunt regulator TL431. A cathode end of the adjustable shunt regulator TL431 is coupled to an end of an LED in the photo-coupler PC, and an anode end thereof is grounded. The other end of the LED in the photo-coupler PC is coupled to the output voltage Vout through a resistor R to receive an electric energy for lighting and so outputs a feedback detection signal FB. A compensation circuit CN may be coupled between the cathode end and the reference end of the adjustable shunt regulator TL431 for stabilizing the control loop. However, some systems are to being frequently switched and needs a fast transient response and the transient response of the adjustable shunt regulator TL431 cannot meet the request of the systems, especially for driving a nonlinear load.

FIG. 2 is a schematic diagram of a conventional LCD Integrated Power System (LIPS) with LED burst dimming. The feedback detection circuit in the left side of FIG. 2 is substantially the same as that shown in FIG. 1, except for the output voltage Vout being replaced with a system voltage VCC. In the right side of FIG. 2, a positive terminal of an LED module LD is coupled to a driving voltage VLED, a negative terminal thereof is coupled to a transistor switch M. The transistor switch M is turned on and off in response to a pulse width modulated (PWM) dimming signal DIM. A positive terminal of a diode D1 is coupled to a voltage-dividing point of the voltage divider VD, and a negative terminal thereof is coupled to the negative terminal of the LED module LD. When the transistor switch M is turned off, a level of the negative terminal of the LED module LD is raised. At this time, the diode D1 is reverse-biased and so an operational point of the adjustable shunt regulator TL431 is determined by a voltage of the voltage-dividing point of the voltage divider VD (hereafter referred as “State 1”). When the transistor switch M is turned on, the level of the negative terminal of the LED module LD is lowered to make the diode D1 forward-biased, and so the operational point of the adjustable shunt regulator TL431 is determined by the voltage of the negative terminal of the LED module LD (hereafter referred as “State 2”). Hence, the feedback detection circuit is switched between the State 1 and the State 2. In the State 1, the LED module LD does not emit light and so it becomes no-load. At this moment, a power source system (not shown) which provides the driving voltage VLED stops supplying energy to the LED module LD. In the State 2, the LED module LD emits light and so it is full-load. At this moment, the power source system has to immediately supply a sufficient power to stabilize an illumination of the LED module LD at a predetermined value. Nevertheless, the power supply system cannot instantaneously transfer from a no-load state into a full-load state which is limited by the transient response of the adjustable shunt regulator TL431. It results in that the LED module flickers during the moment of the State 1 is just switched to the State 2.

### SUMMARY OF THE INVENTION

In view of that the slow transient response of the conventional of feedback detection circuit limits the applicable scope, the present invention uses a signal limitation circuit to restrict a level of a feedback signal generated by the feedback detection circuit. Therefore, an operational conversion circuit in the feedback detection circuit has a narrower adjusted operation range while State being switched, even no adjusted operation range, thereby equivalently enhancing the transient response.

To accomplish the aforementioned and other objects, an exemplary embodiment of the invention provides a feedback detection circuit, adapted to provide a feedback detection signal, wherein a converting circuit generates a driving power to drive a load according the feedback detection signal. The feedback detection circuit comprises an operational conversion circuit and a signal limitation circuit. The operational conversion circuit generates the feedback detection signal according to a level of a detected node coupled to the load, wherein the operational conversion circuit has an operational amplifier which is coupled to the detected node and adjusts a magnitude of the feedback detection signal in response to the level of the detected node. The signal limitation circuit is coupled to the operational conversion circuit for clamping a level range of the feedback detection signal.

To accomplish the aforementioned and other objects, an exemplary embodiment of the invention further provides a feedback detection circuit, adapted to provide a feedback detection signal, wherein a converting circuit generates a driving power to drive a load according to the feedback detection signal. The feedback detection circuit comprises an operational conversion circuit and a signal limitation circuit.

The operational conversion circuit generates a feedback detection signal according to a level of a detected node, wherein the operational conversion circuit has an operational amplifier, which is coupled to the detected node and adjusts a magnitude of the feedback detection signal in response to the level of the detected node. The signal limitation circuit is coupled to the operational conversion circuit and determining whether controlling the feedback detection signal according to a pulse signal, wherein the signal limitation circuit restricts a level of the feedback detection signal to a predetermined level when the pulse signal is in a first logical state, and ceases restricting the level of the feedback detection signal when the pulse signal is in a second logical state.

It is to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The present invention will now be specified with reference to its preferred embodiment illustrated in the drawings, in which:

FIG. 1 is a schematic diagram of a conventional photo-coupler feedback circuit.

FIG. 2 is a schematic diagram of a conventional LCD Integrated Power System (LIPS) with LED burst dimming.

FIG. 3 is a block diagram of a feedback detection circuit according to the present invention.

FIG. 4 is a schematic diagram of an LED burst dimming system with a feedback detection circuit according to a first embodiment of the present invention.

FIG. 5 is a schematic diagram of a feedback detection circuit according to a second embodiment of the present invention.

FIG. 6 is a schematic diagram of a feedback detection circuit according to a third embodiment of the present invention.

FIG. 7 is a schematic diagram of a feedback detection circuit according to a fourth embodiment of the present invention.

### DESCRIPTION OF THE PREFERRED EMBODIMENT

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

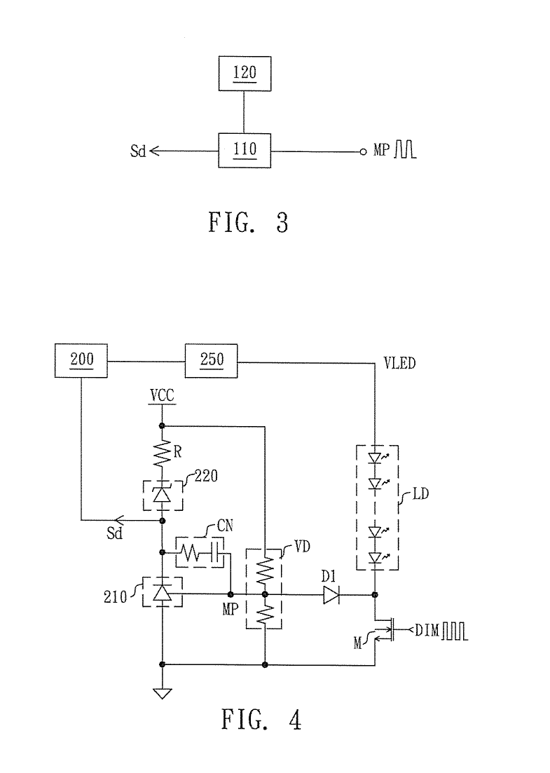

FIG. 3 is a block diagram of a feedback detection circuit according to the present invention. The feedback detection circuit comprises an operational conversion circuit 110 and a signal limitation circuit 120. The operational conversion circuit 110 generates a feedback detection signal Sd according to a level MP of a detected node coupled to a load (not shown). The signal limitation circuit 120 is coupled to the operational conversion circuit 110, for clamping a level range of the feedback detection signal Sd, such as lowering a maximum level of the feedback detection signal Sd, heightening a minimum level of the feedback detection signal Sd, etc. The starting level of the feedback detection signal Sd is a level lower than the maximum level or higher than the minimum level while the feedback detection circuit is switched in response to the level MP of the detected node. Therefore, the feedback detection circuit has a narrower operation range needed to adjust and so the adjusted time period is also shortened, i.e., the transient response is enhanced. Alternatively, the present invention may directly restrict a level of the feedback detection signal Sd to a predetermined level when a pulse signal (e.g. a dimming signal) represents a “OFF” state. Hence, the feedback detection circuit of the present invention is adapted to provide the feedback detection signal Sd to a converting circuit (not shown), wherein the converting circuit supplies a driving power according to the feedback detection signal Sd to drive the load, and meets the request for fast transient response of the operation state being frequently switched.

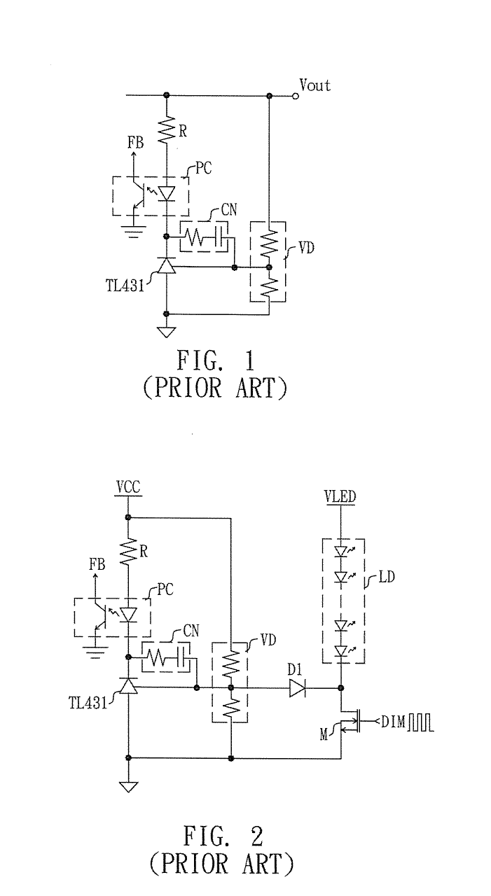

FIG. 4 is a schematic diagram of an LED burst dimming system with a feedback detection circuit according to a first embodiment of the present invention. For more clearly understanding the advantages of the present invention, the LED burst dimming system of the present embodiment is based on the LIPS with LED burst dimming shown in FIG. 2. Certainly, the feedback detection circuit of the present invention is also applicable to other circuit, such as a circuit system for driving a linear load. In the present embodiment, the feedback detection circuit comprises an operational conversion circuit 210 and a signal limitation circuit 220. The operational conversion circuit 210 is an adjustable shunt regulator, and generates a feedback detection signal Sd according to a level MP of a detected node. The feedback detection signal Sd is transmitted to a converting controller 200, for controlling the voltage converting circuit 250 to supply the driving voltage VLED. The signal limitation circuit 220 is coupled between the operational conversion circuit 210 and the resistor R, for restricting a maximum level of the feedback detection signal Sd, i.e., limiting a level range of the feedback detection signal Sd. In the present embodiment, the signal limitation circuit 220 comprises a zener diode. When the transistor switch M is turned off, the level of the negative terminal of the LED module LD is raised. At this time, the diode D1 is reverse-biased, and so the level MP of the detected node is raised. Then, the operational conversion circuit 210 reduces a current inputted into the cathode end thereof, and so a level of the feedback detection signal Sd is raised until that the signal limitation circuit 220 is cut off due to a voltage there across being lower than a breakdown voltage of the zener diode. Compared with the adjustable shunt regulator TL431 in FIG. 2, whose cathode end has a level close to the system voltage VCC, the maximum level of the feedback detection signal Sd is reduced by the signal limitation circuit 220 in the present embodiment. The converting controller 200 decrease an output power of the voltage converting circuit 250 with the level of the feedback detection signal Sd raising. On the other hand, when the transistor switch M is turned on, the level of the negative terminal of the LED module LD is lowered. At this time, the diode D1 is forward-biased, and so the level MP of the detected node starts being reduced from a level lower than that the system voltage VCC subtracts a breakdown voltage of the zener diode. Hence, the operational conversion circuit 210 has a narrower operation range needed to adjust and so enhances the transient response.

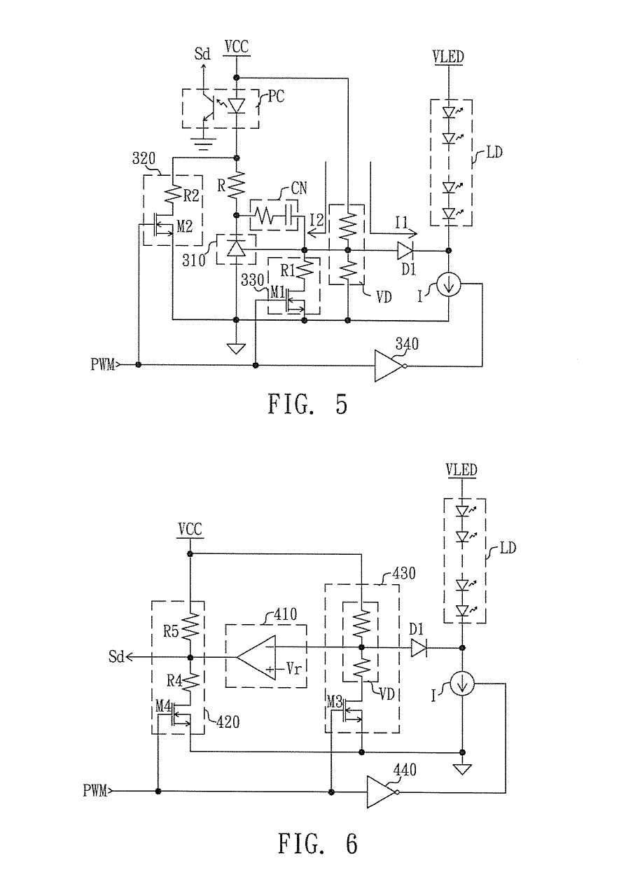

FIG. 5 is a schematic diagram of a feedback detection circuit according to a second embodiment of the present invention. The feedback detection circuit comprises an operational conversion circuit 310, a signal limitation circuit 320 and a state control circuit 330. Compares with that shown in FIG. 4, the transistor switch M is replaced with a controlled current source I in the present embodiment. The operational conversion circuit 310 is coupled to a photo-coupler PC to generate a feedback detection signal Sd for isolation. The signal limitation circuit 320 comprises a transistor M2 and a resistor R2 connected in series. One end of the signal limitation circuit 320 is coupled to the operational conversion circuit 310 through the resistor R, and the other end thereof is grounded. The state control circuit 330 comprises a transistor M1 and a resistor R1 connected in series. One end of the state control circuit 330 is coupled to the operational conversion circuit 310, and the other end thereof is grounded. In the present embodiment, the transistor may be a metal oxide silicon field effect transistor, a bipolar junction transistor or other devices with switching function.

A pulse width modulated signal PWM is used to turn on/off the transistor M2 of the signal limitation circuit 320 and the transistor M1 of the state control circuit 330, as well as the controlled current source I through an inverter 340. When the pulse width modulated signal PWM is at low level (hereafter referred as second logical state), the controlled current source I supplies a predetermined current to light an LED module LD. Simultaneously, the transistors M1 and M2 are turned off and so the signal limitation circuit 320 and the state control circuit 330 do not function. At this time, a voltage divider VD provides a current I1 flowing through a diode D1. When the pulse width modulated signal PWM is at high level (hereafter referred as first logical state), the controlled current source I stops providing the current, and so the LED module LD stops emitting light. At this time, the transistor M2 is turned on, and so the current flowing through the photo-coupler PC is raised to lower the level of the feedback detection signal Sd. Thereby, a converting circuit (not shown) that receiving the feedback detection signal Sd decreases the output power of the LED module LD. Simultaneously, the transistor M1 is turned on, and so the voltage divider VD provides a current I2 flowing through the state control circuit 330. The current I2 may be set to be close to the current I1, for maintaining the state of the operational conversion circuit 310 at a state close to that when the pulse width modulated signal PWM is in the second logical state. Preferably, the current I2 is equal to the current I1. The state control circuit 330 provides a substitution level to replace an original level of a detected node when the pulse width modulated signal PWM is in the first logical state. Thereby, states of at least part circuits of the operational conversion circuit 310 are close or equal no matter when the pulse width modulated signal PWM is in the first logical state and the second logical state to enhance the transient response.

FIG. 6 is a schematic diagram of a feedback detection circuit according to a third embodiment of the present invention. In the present embodiment, an operational conversion circuit 410 comprises an operational amplifier to replace the adjustable shunt regulator shown in FIG. 5. In general, the adjustable shunt regulator may have an operational amplifier therein. The function of the compensation circuit CN is to compensate the feedback control, not necessary for some application. Furthermore, the photo-coupler may be not necessary for some application without isolation request. Therefore, the compensation circuit CN and the photo-coupler are omitted in the present embodiment. The feedback detection circuit comprises an operational conversion circuit 410, a signal limitation circuit 420 and a state control circuit 430. The signal limitation circuit 420 comprises a transistor M4 and a resistor R4 connected in series. The state control circuit 430 comprises a voltage divider VD and a transistor M3.

When a pulse width modulated signal PWM is in the second logical state, a controlled current source I provides a predetermined current to light the LED module LD. Simultaneously, all the transistors M3 and M4 are turned off, and so the signal limitation circuit 420 and the state control circuit 430 do not function. An inverting end of the operational amplifier of the operational conversion circuit 410 is coupled to a negative terminal of the LED module LD through a diode D1, and a non-inverting end thereof receives a reference voltage Vr. Accordingly, the operational conversion circuit 410 outputs a feedback detection signal Sd. At this time, the transistor M4 is turned off and so the signal limitation circuit 420 does not restrict a level of the feedback detection signal Sd. When the pulse width modulated signal PWM is in the first logical state, the controlled current source I stops providing the current and so the LED module LD stops emitting light. The level of the negative terminal of the LED module LD is raised. At this time, the transistor M3 is turned on, the level of the inverting end of the operational amplifier in the operational conversion circuit 410 is restricted to a level by the voltage divider VD of the state control circuit 430. Thereby, the diode D1 is reverse-biased and the state of the operational amplifier of the operational conversion circuit 410 is maintained. Simultaneously, the transistor M4 is turned on, the level of the feedback detection signal Sd is restricted to a predeteimined level by the resistors R4 and R5 and so the converting circuit (not shown) reduces the power supplied to the LED module LD. When the pulse width modulated signal PWM is in the first logical state and the second logical state, the states of the operational conversion circuit 410 are closer than that in conventional arts, and so the transient response is enhanced.

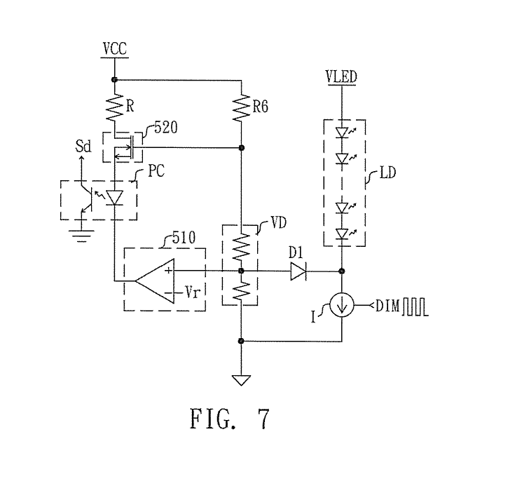

FIG. 7 is a schematic diagram of a feedback detection circuit according to a fourth embodiment of the present invention. In the present embodiment, an operational conversion circuit 510 comprises an operational amplifier and a signal limitation circuit 520 comprises a transistor coupled to the operational conversion circuit 510 through a photo-coupler PC. A converting circuit (not shown) generates a driving voltage VLED to drive an LED module LD lighting. A controlled current source I provides or stops providing a current flowing through the LED module LD in response to a PWM dimming signal DIM. A voltage divider VD is coupled to a system voltage VCC through a resistor R6 to provide a voltage-dividing signal to a non-inverting end of the operational amplifier of the operational conversion circuit 510. An inverting end of the operational amplifier receives a reference voltage Vr. A positive terminal of a diode D1 is coupled to the non-inverting end of the operational amplifier, and a negative terminal thereof is coupled to a negative terminal of the LED module LD. The operational conversion circuit 510 is coupled to the photo-coupler PC to generate a feedback detection signal Sd. When the PWM dimming signal DIM is at high level, the controlled current source I provides a predetermined current to light the LED module LD. At this time, the level of the negative terminal of the LED module LD is lower and so the diode D1 is forward-biased to lower the level of the voltage-dividing point of the voltage divider VD. At this time, a level of an output signal generated by the operational amplifier of the operational conversion circuit 510 is lowered, and so the transistor of the signal limitation circuit 520 is turned on. The photo-coupler PC generates the feedback detection signal Sd according to the level of the output signal of the operational amplifier. When the PWM dimming signal DIM is at low level, the controlled current source I stops providing the predetermined current and so the LED module LD does not emit light. At this time, the level of the negative terminal of the LED module LD is higher and so the diode D1 is reverse-biased. At this moment, the level of the non-inverting end of the operational amplifier in the operational conversion circuit 510 is determined by the resistor R6 and resistors of the voltage divider VD, but higher than that when the LED module LD lighting. Therefore, the level of the output signal of the operational amplifier is raised. A control end of the transistor of the signal limitation circuit 520 is coupled to the resistor R6, and so the level of the control end is also determined by the resistor R6 and the resistors of the voltage divider VD. Accordingly, a level of a connection node of the signal limitation circuit 520 and the photo-coupler PC is raised to a level that lower than a level of a connection node of the resistor R 6 and the voltage divider VD at a predetermined voltage. Namely, when the output signal of the operational conversion circuit 510 is higher than a predetermined clamp level, the transistor of the signal limitation circuit 520 is turned off to restrict a maximum level of the connection node of the signal limitation circuit 520 and the photo-coupler PC, thereby limiting a level range of the feedback detection signal Sd.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A feedback detection circuit, adapted to provide a feedback detection signal, wherein a converting circuit generates a driving power to drive a load according to the feedback detection signal, the feedback detection circuit comprising:
an operational conversion circuit, generating the feedback detection signal according to a level of a detected node coupled to the load, wherein the operational conversion circuit has an operational amplifier which is coupled to the detected node and adjusts a magnitude of the feedback detection signal in response to the level of the detected node; and
a signal limitation circuit, coupled to the operational conversion circuit for clamping a level range of the feedback detection signal.

2. The feedback detection circuit according to claim 1, wherein the signal limitation circuit comprises a zener diode.

3. The feedback detection circuit according to claim 1, wherein the signal limitation circuit comprises a transistor switch, which is turned off when a level of an output signal of the operational conversion circuit is higher than a predetermined clamp level.

4. The feedback detection circuit according to claim 1, wherein the operational conversion circuit is an adjustable shunt regulator.

5. The feedback detection circuit according to claim 4, wherein the signal limitation circuit comprises a zener diode.

6. The feedback detection circuit according to claim 4, wherein the signal limitation circuit comprises a transistor switch, which is turned off when a level of an output signal of the operational conversion circuit is higher than a predetermined clamp level.

7. A feedback detection circuit, adapted to provide a feedback detection signal, wherein a converting circuit generates a driving power to drive a load according to the feedback detection signal, the feedback detection circuit comprising:
an operational conversion circuit, generating the feedback detection signal according to a level of a detected node, wherein the operational conversion circuit has an operational amplifier, which is coupled to the detected node and adjusts a magnitude of the feedback detection signal in response to the level of the detected node; and
a signal limitation circuit, coupled to the operational conversion circuit and determining whether controlling the feedback detection signal according to a pulse signal, wherein the signal limitation circuit restricts a level of the feedback detection signal to a predetermined level when the pulse signal is in a first logical state, and ceases restricting the level of the feedback detection signal when the pulse signal is in a second logical state.

8. The feedback detection circuit according to claim 7, further comprising a state control circuit, coupled to the operational conversion circuit, wherein the state control circuit provides a substitution level to replace the level of the detected node when the pulse signal is in the first logical state.

9. The feedback detection circuit according to claim 8, wherein the signal limitation circuit comprises a transistor switch, which is switched in response to the pulse signal to restrict the level of the feedback detection signal to the predetermined level when the pulse signal is in the first logical state.

10. The feedback detection circuit according to claim 8, wherein the operational conversion circuit is an adjustable shunt regulator.

11. The feedback detection circuit according to claim 8, wherein the state control circuit comprising a transistor switch, which is switched in response to the pulse signal, and provides the substitution level when the pulse signal is in the first logical state.

12. The feedback detection circuit according to claim 7, wherein the signal limitation circuit comprises a transistor switch, which is switched in response to the pulse signal to restrict the level of the feedback detection signal to the predetermined level when the pulse signal is in the first logical state.

13. The feedback detection circuit according to claim 7, wherein the operational conversion circuit is an adjustable shunt regulator.
